(19) United States
(12) Patent Application Publication
(10) Pub. No.: US 2015/0062325 A1
(43) Pub. Date: Mar. 5, 2015

(54) IMAGE ESTIMATING METHOD, PROGRAM, RECORDING MEDIUM, IMAGE ESTIMATING APPARATUS, NETWORK DEVICE, AND METHOD OF OBTAINING IMAGE DATA

(71) Applicant: CANON KABUSHIKI KAISHA, Tokyo (JP)

(72) Inventor: Akira Eguchi, Tucson, AZ (US)

(73) Assignee: CANON KABUSHIKI KAISHA, Tokyo (JP)

(21) Appl. No.: 14/391,900

(22) PCT Filed: May 15, 2013
(86) PCT No.: PCT/JP2013/064140

§ 371 Date: Oct. 10, 2014

(30) Foreign Application Priority Data
May 16, 2012 (JP) 2012-112227

(51) Int. Cl. G06T 5/50

(52) U.S. Cl. CPC G06T 5/50; G06T 2207/10056; G06T 2207/20056; G06T 2207/20221; G06T 2207/30024
USPC 348/80

(57) ABSTRACT

An image estimating method is configured to utilize image data of an object captured at N different positions zⱼ that are spaced from each other at an interval Δz in an optical axis direction, and to estimate image data at a position z in the optical axis direction. N is an integer of 2 or larger. The image estimating method includes the steps of an image converting step of performing a frequency conversion for N pieces of image data in the optical axis direction, and of calculating N pieces of converted image data, and a coupling step of multiplying the N pieces of converted image data by a complex number determined for the N pieces of converted image data based upon z and Δz, and of summing up multiplied results.

### TECHNICAL FIELD

The present invention relates to an image estimating method, a program, a recording medium, an image estimating apparatus, a network device, and a method of obtaining image data, each used to estimate an image at an arbitral focus position.

### BACKGROUND ART

A virtual slide system uses a digital image pickup apparatus called a virtual slide to obtain a digital image of an object. In the medical field, a sample covered with and fixed by an optical element (cover glass) (prepared specimen: präparat) is generally used as an object. The virtual slide includes a microscope optical system, an image sensor, and an information processor, converts the prepared specimen into a digital image, and stores the resultant data. This type of apparatus stores a digital image of the prepared specimen, and enables only a captured image at the focus position to be viewed after the image is taken. A medical doctor often determines a three-dimensional structure of the sample using a plurality of images obtained at different focus positions, and thus a plurality of images captured at different focus positions are necessary.

Obtaining many images requires a longer capturing time and a larger amount of data. It is thus desirable to minimize the number of captured images. However, the reduced number of captured images would be unable to provide an image at a focus position requested by the medical doctor in the diagnosis. As a method of compromising two demands for reducing the number of captured images and for providing an image at an arbitrary focus position, there are proposed methods of estimating an image at a necessary focus position utilizing image processing (PLT1 and NPLT1).

PLT1 proposes a method for estimating an image utilizing a defocus filter of an optical system for images obtained at a plurality of focus positions. NPLT1 proposes a method for expressing an image using a function of a focus position z and for estimating an approximate image by expanding a z polynomial.

### CITATION LIST

### Patent Literature

[PTL 1] Japanese Patent Laid-Open No. 2001-223874

### Non-Patent Literature

[NPTL 1] Kenji Yamazoe and Andrew R. Neureuther, “Modeling of through-focus aerial image with aberration and imaginary mask edge effects in optical lithography simulation” Applied Optics, Vol. 50, No. 20, pp. 3570-3578, 10 Jul. 2011, USA

### SUMMARY OF INVENTION

### Technical Problem

According to the method of PLT1, information of the defocus filter of the optical system is required in advance and thus an arduous preliminary measurement or the like is required. Furthermore, this method is inapplicable to a partial coherent imaging system like a microscope. According to the method of NPLT1, the function for the expansion is the z polynomial and the obtained image is an approximated solution. It is thus necessary for the improved precision of the approximation to expand a high order and a very long computing time is required.

The present invention provides an image estimating method, a program, a recording medium, an image estimating apparatus, a network device, and a method of obtaining image data, each used to simply and precisely estimate an image at an arbitrary focus position.

### Solution to Problem

An image estimating method according to the present invention is configured to utilize an operating unit and image data of an object captured by an image pickup apparatus that includes an image pickup optical system, at N different positions zⱼ (1≦j≦N) that are spaced from each other at an interval Δz in an optical axis direction of the image pickup optical system, and to estimate image data at a position z (zₘᵢₙ≦z≦zₘₐₓ) in the optical axis direction. N is an integer of 2 or larger, zₘᵢₙ is a minimum value of z, and zₘₐₓ is a maximum value of z. The image estimating method includes the steps of an image converting step of performing a frequency conversion for N pieces of image data in the optical axis direction, and of calculating N pieces of converted image data, and a coupling step of multiplying the N pieces of converted image data by a complex number determined for the N pieces of converted image data based upon zₘᵢₙ, zₘₐₓ, z and Δz, and of summing up multiplied results.

Further features and aspects of the present invention will become apparent from the following description of exemplary embodiments with reference to the attached drawings.

### Advantageous Effects of Invention

The present invention can provide an image estimating method, a program, a recording medium, an image estimating apparatus, a network device, and a method of obtaining image data, each used to simply and precisely estimate an image at an arbitrary focus position.

### BRIEF DESCRIPTION OF DRAWINGS

FIG. 1 is a block diagram of a virtual slide according to first to eighth embodiments of the present invention.

FIG. 2 is a flowchart from an image acquisition of an object to displaying the image according to the first to eighth embodiments of the present invention.

FIG. 3 is a flowchart of the image acquisition according to the first to eighth embodiments of the present invention.

FIGS. 4A and 4B are optical systems for explaining a principle according to the first to eighth embodiments of the present invention.

FIG. 5 illustrates a section at f_{y}=0 of CTF according to the first to eighth embodiments.

FIG. 6 is an amplitude transmittance distribution of the object according to the first to eighth embodiments.

FIG. 7 illustrates object images obtained at different focus positions according to the first to eighth embodiments.

FIGS. 8A and 8B illustrate estimated images obtained by an image estimating method according to the first embodiment of the present invention.

FIG. 9 is a graph illustrating a relationship between a focus position and PSNR for image estimations by the image estimating method according to the first embodiment of the present invention.

FIGS. 10A and 10B illustrate estimated images obtained by an image estimating method according to the second embodiment of the present invention.

FIG. 11 is a graph illustrating a relationship between a focus position and PSNR for image estimations by the image estimating method according to the second embodiment of the present invention.

FIG. 12 is a flowchart of an image estimating method according to the third and fourth embodiments of the present invention.

FIGS. 13A and 13B illustrate estimated images obtained by an image estimating method according to the third embodiment of the present invention.

FIG. 14 is a graph illustrating a relationship between a focus position and PSNR for an image estimation of the image estimating method according to the third embodiment of the present invention.

FIGS. 15A and 15B illustrate estimated images obtained by an image estimating method according to the fourth embodiment of the present invention.

FIG. 16 is a graph illustrating a relationship between a focus position and PSNR for image estimations by the image estimating method according to the fourth embodiment of the present invention.

FIGS. 17A and 17B illustrate estimated images obtained by an image estimating method according to the fifth embodiment of the present invention.

FIG. 18 is a graph illustrating a relationship between a focus position and PSNR for image estimations by the image estimating method according to the fifth embodiment of the present invention.

FIGS. 19A and 19B illustrate estimated images obtained by an image estimating method according to the sixth embodiment of the present invention.

FIG. 20 is a graph illustrating a relationship between a focus position and PSNR for image estimations by the image estimating method according to the sixth embodiment of the present invention.

FIG. 21 is a graph of the PSNR worst value found by changing the image obtaining interval Δz and a central shield size ε of a pupil of an image pickup optical system according to the seventh embodiment.

FIG. 22 is a graph of the image obtaining interval Δz with the PSNR worst value of 35 dB found by changing a central shield size ε of a pupil in an image pickup optical system according to the seventh embodiment.

FIG. 23 is a graph of the PSNR worst value found by changing the image obtaining interval Δz and a central shield size ε of a pupil in an illumination optical system according to an eighth embodiment.

FIG. 24 is a graph of the image acquisition step Δz with the PSNR worst value of 35 dB found by changing a central shield size ε of a pupil of an image pickup optical system according to an eighth embodiment.

FIG. 25 is a flowchart of an operation in designating a display position from a network device according to a ninth embodiment of the present invention.

### DESCRIPTION OF EMBODIMENTS

The present invention relates to an image estimating method configured to estimate an image at an arbitrary position based upon images of a sample captured by an image pickup apparatus that includes an image pickup optical system. The image estimating method is implemented as a computer executable program and may be recorded in a recording medium, etc.

The image may be estimated in the image pickup apparatus or an image estimating apparatus (computer) connected to the storage (memory) configured to store the images captured by the image pickup apparatus. The image pickup apparatus may serve as an image estimating apparatus. An obtained image may be displayed on a display unit connected to the image pickup apparatus or the image estimating apparatus, and a network device connected through a network, such as the LAN, WAN, and Internet. In this case, the image estimating method can utilize cloud computing, and the network device may be a desktop personal computer (“PC”) configured to designate (input) a position and to receive image data and may be connected to a display unit, such as a display. Alternatively, the network device may be a portable terminal, such as an iPad®, a laptop PC, and a dedicated terminal, such as a PDA, which includes a display unit, such as a touch screen. Thereby, a remote diagnosis is available.

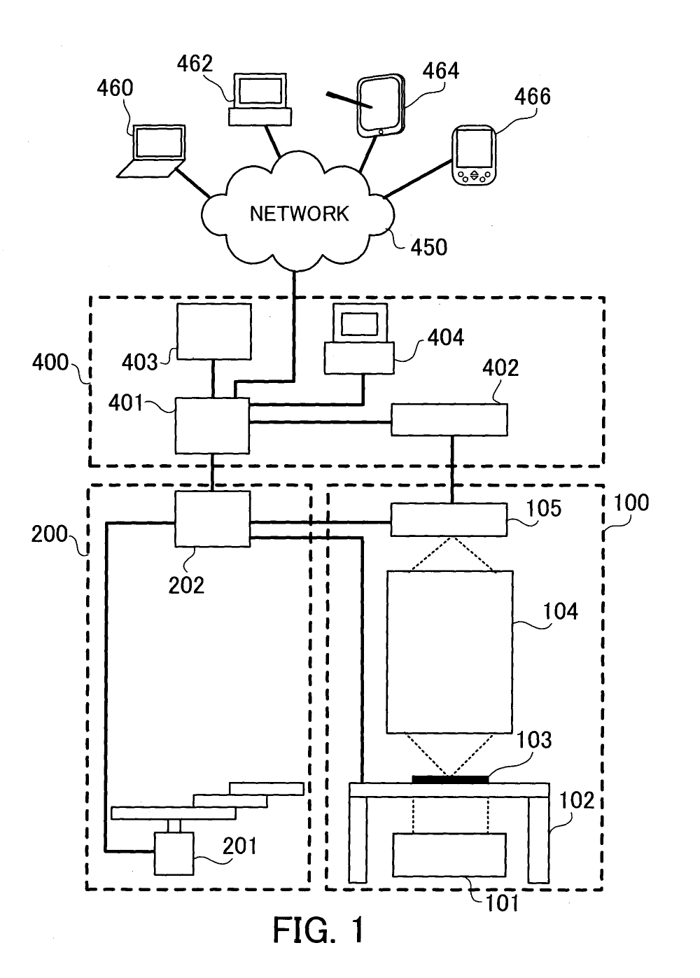

FIG. 1 is a block diagram of a virtual slide according to the embodiments of the present invention. The virtual slide includes an image pickup unit (apparatus) 100, a control unit 200, an information processing unit (image estimating apparatus) 400.

The control unit 200 includes a transporter 201 and a controller 202. The transporter 201 moves an object 103 onto a movable stage 102 under an instruction of the controller 202. The movable stage 102 can move in the optical axis direction in accordance with the instruction of the controller 202. The movable stage 102 may move in a direction perpendicular to the optical axis. Images can be obtained at different focus positions utilizing the movable stage 102.

The image pickup unit 100 is configured to obtain the image of the object 103, and includes an illumination optical system 101, the movable stage 102, an optical system (image pickup optical system) 104, and an image sensor 105.

The object 103 placed on the movable stage 102 is illuminated by the illumination optical system 101, and an enlarged optical image of the object is formed on the image sensor 105 by the optical system 104. The image sensor 105 is a photoelectric converter (photoelectric conversion element) configured to photoelectrically convert the enlarged optical image of the object. The electric signal output from the image sensor 105 is transmitted as image data to the information processing unit 400.

The information processing unit 400 includes a computer (operating unit) 401, an image processor 402, a data storage (memory) 403, and a display unit 404.

The image processor 402 converts the image data sent from image sensor 105 into a digital signal. This digital signal is called a brightness signal. The image processor 402 performs image processing, such as a noise reduction and a compression, for image data that has been converted into the brightness signal, and sends it to the computer 401. The computer 401 forwards the transmitted data to the data storage 403. The data storage 403 stores the sent image data. In the diagnosis, the computer 401 reads the image data from data storage 403. The computer 401 performs the image processing for the read image data, and converts it into image data at the focus position designated by the user. The converted image data is forwarded to the display unit 404, and the image is displayed.

The computer 401, the image processor 402, the data storage 403, the display unit 404, and the controller 202 may be included in one computer. The data may be stored in an external server connected to the network 450 and in this case, a plurality of persons can remotely access the data. The computer 401 is connected with a variety of network devices through the network 450. These network devices include a laptop PC 460, a desktop PC 462, a portable terminal 464 that has a touch screen function, and a dedicated terminal 466 such as a PDA.

The network device has an operating unit, a display unit, a designating unit, a communication unit, and a storage unit. The operating unit is a computer (processor) configured to control each component and provide necessary operations. The display unit may be integrated with a housing of each of the network devices 460, 464, and 466, or may be a display unit or the like connected to the network device like the network device 462. The designating unit includes an inputting unit, such as a touch screen, a keyboard, a stylus pens, a mouse, etc. configured to enable the user to designate an arbitrary position z in the optical axis direction of the optical system 104. The communication unit is connected with the network 450, transmits information of the position z to the image estimating apparatus, and receives information of the image data of the object 103 at the position z from the image estimating apparatus. The information of the image data may be a still image such as jpeg, or a function I(x,y,z) that represents a brightness distribution (distribution of pixel values), which will be described later. The storage unit is a memory that stores an application program configured to enable the position z to be designated. Each of the network devices 460, 464, and 466 further includes a display unit configured to display the image at the position z on the basis of information on the image data received through the communication unit.

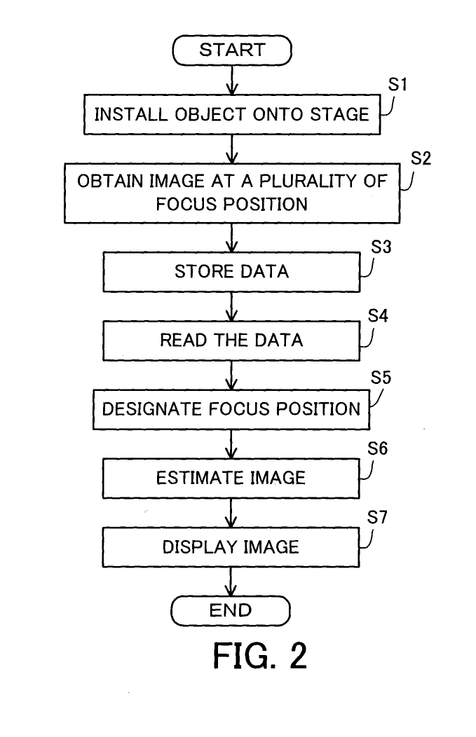

FIG. 2 is a flowchart from the image acquisition of the object to displaying the image. “S” stands for the step, and this is true of other flowcharts. Obtaining an enlarged image of the object 103 as the image data by using the image sensor 105, the image processor 402, and the computer 401 is referred to as the image acquisition.

In S1, the object 103 is installed into the movable stage 102 using the transporter 201 and in S2, the image of the object 103 is obtained at a plurality of focus positions. In S3, a series of acquired images is stored in the data storage 403. In S4, in the diagnosis, the stored data is read out. When the image acquisition and the diagnosis of object 103 are simultaneously performed, the data may be temporarily stored. In S5, the user sets a desired focus position. A preset value may be read out for the focus position or the focus position may be calculated based upon a surface shape of the sample obtained in the preliminary measurement. In S6, the image is estimated at a set focus position. In S7, the estimated image is sent to the display unit 404 and displayed on it. The image acquisition and the display of the image are performed in accordance with the above flow.

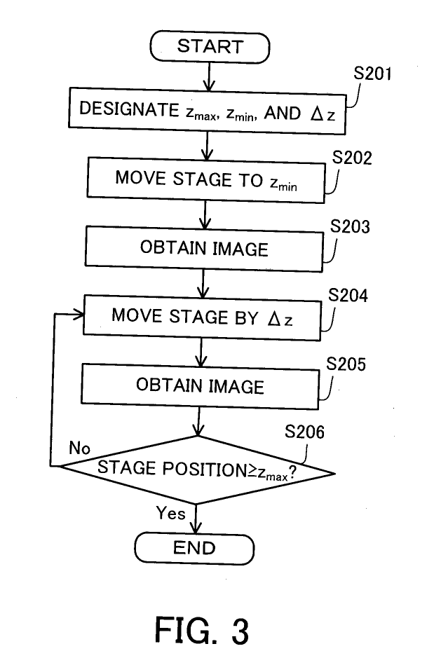

A detailed description will now be given of the image acquisition of the object 103 in S2. FIG. 3 is a flowchart of the image acquisition.

Initially, in S201, a range and a moving amount of the stage position in the optical axis direction (z direction) are set. zⱼ denotes a defocus amount in the propagating direction of the straightforward moving light, and a position conjugate with the image sensor 105 with respect to the optical system 104 is set to an origin. zⱼ is synonymous with the focus position and the stage position in the optical axis direction. A range zₘₐₓ˜zₘᵢₙ of zⱼ in which images are obtained in S201 and a moving amount (interval) Δz of the stage used to obtain an image are set.

In other words, the object 103 is captured using the optical system 104 at N different positions zⱼ (1≦j≦N) determined by the interval Δz in the optical axis direction of the optical system 104, and the image data of the object 103 is obtained. A maximum value of zⱼ is zₘₐₓ and a minimum value of zⱼ is zₘᵢₙ.

These values may be set based upon the surface shape of a sample that has been measured in advance to S201, or may be arbitrarily set by the user. A preset value, which has been prepared, may be used. Next, in S202, the movable stage 102 is moved to the position of zₘᵢₙ and in S203, the image of the object 103 is obtained. After the image acquisition ends, the movable stage 102 is moved by Δz in S203 and the image is obtained in S205. S204 and S205 are repeated until the position of the movable stage 102 reaches or goes beyond zₘₐₓ. Thus, a plurality of or N pieces of image data of the object 103 are obtained at different focus positions.

A moving method of the movable stage 102 is not limited to the above method. For example, in S202, the movable stage 102 is moved to zₘₐₓ and then moved by −Δz so as to obtain images.

According to the present invention, an image at an arbitrary focus position is estimated based upon image data acquired at a plurality of focus positions. The principle will be described.

A description will be given of an expression that provides an intensity distribution of an optical image formed on the image sensor plane by the image pickup optical system.

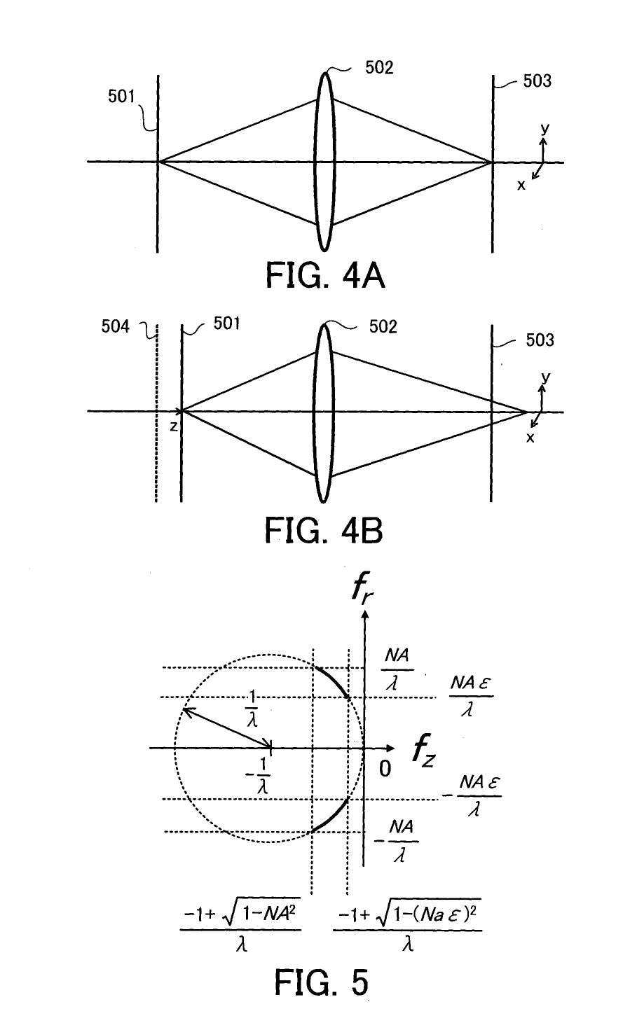

FIGS. 4A and 4B illustrate an optical system so as to explain the principal. FIG. 4A illustrates the optical system when an image of the object 501 is formed by the image pickup optical system 502 on an image sensor 503. FIG. 4B illustrates the optical system when the object 501 shifts from the original position 504 in the optical axis direction by z relative to FIG. 4A.

Initially, assume that the illumination light is perfectly coherent and vertically incident light. An imaging expression when the image of the object 501 is formed on the image sensor 503 is given as follows:

I(x,y)=|ℑ₂⁻¹[O(fₓ,f_{y})P(fₓ,f_{y})]|² Expression 1

I(x,y) is an image intensity distribution on the image sensor 503, and O(fₓ,f_{y}) is a diffracted light distribution from an object. P(fₓ,f_{y}) is a pupil function of the optical system, x and y forms an orthogonal coordinate perpendicular to the optical axis on the image plane, fₓ is a spatial frequency in the x direction, f_{y} is a spatial frequency in the y direction, and ℑ denotes a Fourier transform. “2” of the subscript of ℑ means a two-dimensional Fourier transform (frequency conversion) in the two orthogonal x and y directions orthogonal to the optical axis direction, and “−1” of the superscript means an inverse Fourier transform (inverse frequency conversion). As illustrated in FIG. 4B, the imaging expression when the object 501 moves by z in the optical axis direction will be given as follows:

I(x,y,z)=|ℑ₂⁻¹[O(fₓ,f_{y})P(fₓ,f_{y};z)]|² Expression 2

P(fₓ,f_{y};z) is expressed by Expression 3 as a pupil function that is provided with a defocus aberration equivalent with the defocus of the object:

$$P ( {f}_{x} , {f}_{y} ; z ) = circ ( \frac{λ {f}_{r}}{NA} ) \{ 1 - circ ( \frac{λ {f}_{r}}{NA ɛ} ) \} exp ( i {k}_{z 0} z - i {k}_{z} z ) \qquad Expression 3$$

Herein, λ denotes a wavelength of the illumination light, NA denotes a numerical aperture of the image pickup optical system on the object side, k_{z0} is a z direction component of the wave number of the illumination light, and k_{z} is a z direction component of the wave number of the diffracted light. fᵣ=(fₓ²+f_{y}²)^{1/2} is established. For simplicity, it is assumed that the magnification is once (equal magnification). It is also assumed that the pupil plane in the image pickup optical system has a circular shield at the center, and its radius is ε times as large as the radius of the pupil. This embodiment assumes that light is shielded near the center of the pupil plane but the present invention is not limited to this embodiment. A similar effect can be expected as long as the light intensity near the center of the pupil plane is lower than that of the periphery. It is unnecessary to arrange the shield on the pupil plane of the image pickup optical system. The shield is not necessarily circular. A filter that is designed so that the light intensity distribution on the pupil plane becomes low near the center may be arranged in the optical path of the image pickup optical system. When there is no central shield, a curl in Expression 3 may be omitted.

A z direction component of wave number is expressed by Expressions 4 and 5:

$$\begin{matrix}{k}_{z} = 2 π \sqrt{\frac{1}{{λ}^{2}} - {f}_{r}^{2}} & Expression 4 \\ {k}_{z 0} = 2 π \sqrt{\frac{1}{{λ}^{2}} - {f}_{r 0}^{2}} & Expression 5\end{matrix}$$

fₓ₀ and f_{y0} are values made by dividing a wave number component in each of x and y directions of the incident light by 2π. fᵣ₀=(fₓ₀²+f_{y0}²)^{1/2} is established. In the vertical incidence, fₓ₀=f_{y0}=0 is established. A circ function is expressed by Expression 6:

$$circ ( {f}_{r} ) = \{ \begin{matrix}1 & {f}_{r} \leq 1 \\ 0 & {f}_{r} > 1\end{matrix} \} \qquad Expression 6$$

The image data obtained at different focus positions corresponds to I(x,y,z) of the Expression 2 obtained with different z. The Expression 2 contemplates that the object moves in the optical axis direction but a similar discussion is also applicable when the image sensor is moved in the optical axis direction.

Now assume an area where the spectrum of I(x,y,z) has non-0. When I(x,y,z) is Fourier-transformed for each coordinate, the Expression 2 is modified to Expression 7: Expression 7

ℑ₃[I(x,y,z)]=O(fₓ,f_{y})CTF(fₓ,f_{y},f_{z})\textcircled{x}₃O*(−fₓ,−f_{y})CTF(−fₓ,−f_{y},−f_{z})

Herein, CTF(fₓ,f_{y},f_{z}) is expressed by Expression 8, which is a function made by Fourier-transforming a pupil function with respect to z, and represents a characteristic of the image pickup optical system. \textcircled{x} denotes a convolution integral, and the subscript of 3 means convolution integrals for three coordinates of fₓ, f_{y}, and f_{z}. The superscript of * denotes a complex conjugate. The subscript of 3 of ℑ denotes a three-dimensional Fourier transform for three coordinates x, y, and z:

$$C T F ( {f}_{x} , {f}_{y} , {f}_{z} ) = circ ( \frac{λ {f}_{r}}{N A} ) \{ 1 - circ ( \frac{λ {f}_{r}}{NA ɛ} ) \} δ ( {f}_{z} + \sqrt{\frac{1}{{λ}^{2}} - {f}_{r 0}^{2}} - \sqrt{\frac{1}{{λ}^{2}} - {f}_{r}^{2}} ) \qquad Expression 8$$

FIG. 5 illustrates a section at f_{y}=0 of CTF(fₓ,f_{y},f_{z}). According to Expression 8, the CTF is a product between the circ function and the δ function. According to the characteristic of the δ function, the CTF becomes non-0 only on the curved surface that satisfies f_{z}+1/λ−(1/λ²−fᵣ²)^{1/2}=0. This corresponds to a spherical surface having a center of f_{z}=−1/λ and a radius of 1/λ in the space frequency space. In addition, according to the characteristic of the circ function, CTF(fₓ,f_{y},f_{z}) becomes non-0 from only when NAε/λ≦fᵣ≦NA/λ. is satisfied. Thus, CTF(fₓ,f_{y},f_{z}) becomes non-0 only in the region of thick line parts in FIG. 5. According to FIG. 5, the region of f_{z} in which CTF(fₓ,f_{y},f_{z}) becomes non-0 is limited to a case where Expression 9 is satisfied:

$$- \frac{1 - \sqrt{1 - {NA}^{2}}}{λ} \leq {f}_{z} \leq - \frac{1 - \sqrt{1 - {( NA ɛ )}^{2}}}{λ} \qquad Expression 9$$

Since O(fₓ,f_{y}) generally becomes non-0 in the overall region of the space frequency space, the region where the spectrum of I(x,y,z) becomes non-0 is determined by the region in which CTF(fₓ,f_{y},f_{z}) becomes non-0. In order to clarify the region in which the spectrum of I(x,y,z) becomes non-0, assume O(fₓ,f_{y})=1. Then, the spectrum of I(x,y,z) is expressed by the autocorrelation of CTF(fₓ,f_{y},f_{z}). As a result of the autocorrelation, Expression 10 defines a region of f_{z} by which the spectrum of I(x,y,z) becomes non-0:

$$- \frac{1 - \sqrt{1 - {NA}^{2}} - \{ 1 - \sqrt{1 - {( NA ɛ )}^{2}} \}}{λ} \leq {f}_{z} \leq \frac{1 - \sqrt{1 - {NA}^{2}} - \{ 1 - \sqrt{1 - {( NA ɛ )}^{2}} \}}{λ} \qquad Expression 10$$

This result is established with arbitrary O(fₓ,f_{y}).

Expression 11 is used for a partial coherent imaging system instead of the Expression 2:

$$I ( x , y , z ) = {\int }_{- ∞}^{∞} {\int }_{- ∞}^{∞} S ( {f}_{x 0} , {f}_{y 0} ) {\vert {}_{2}^{- 1} [ O ( {f}_{x} , {f}_{y} ) P ( {f}_{x} - {f}_{x 0} , {f}_{y} - {f}_{y 0} ; z ) ] \vert}^{2} d {f}_{x 0} d {f}_{y 0} \qquad Expression 11$$

S(fₓ₀,f_{y0}) is an intensity distribution of the effective optical source. The effective optical source is a light intensity distribution formed on the pupil plane of the imaging optical system when there is no sample. Since the pupil function P in the Expression 11 corresponds to a parallel movement by fₓ₀ and f_{y0} of the pupil function in the Expression 3, the shape of CTF(fₓ,f_{y},f_{z}) derived from the pupil function P in the Expression 11 is the same as the thick lines illustrated in FIG. 5. Hence, the region of f_{z} in which the spectrum is non-0 is determined similar to the complete coherence to the term of the absolute value square of the integrated function in the Expression 11. The Expression 10 gives the region of f_{z} in which the spectrum of I(x,y,z) becomes non-0 in the partial coherent imaging system.

The incoherent imaging system is equivalent to S(fₓ₀,f_{y0})=1, and the Expression 10 defines the region of f_{z} in which the spectrum of I(x,y,z) becomes non-0 in the incoherent imaging system.

As described above, the region of f_{z} in which the spectrum of I(x,y,z) becomes non-0 is limited to the Expression 10 regardless of the image pickup method.

A description will be given of a method for estimating an image at an arbitrary focus position. The following description treats I(x,y,z) as a brightness distribution of the image data obtained at the focus position z. For simplicity purposes, zₘᵢₙ=0 is assumed. “z” in the following expression may be replaced with z−zₘᵢₙ in case of zₘᵢₙ≠0.

A Fourier series expansion (complex Fourier series expansion) is performed for I(x,y,z) using “i” as an imaginary unit with respect to z according to Expression 12:

$$I ( x , y , z ) = {\sum }_{- N / 2 \leq n < N / 2} {I}^{′} ( x , y ; {f}_{zn} ) exp ( - 2 π {if}_{zn} z ) \qquad Expression 12$$

I′(x,y;f_{zn}) is a Fourier coefficient (complex Fourier coefficient) calculated by a discrete Fourier transform expressed by Expression 13 based upon the image data I(x,y,zⱼ) obtained at different focus positions. Since a range of z in which images are obtained is finite, the spatial frequency f_{z} in the z direction becomes discrete f_{zn} (f_{zn}=n/(zₘₐₓ−zₘᵢₙ+Δz)), and is determined by Expression 14 based upon the range zₘₐₓ−zₘᵢₙ of zⱼ. “n” is an integer used to designate the Fourier coefficient I′(x,y;f_{zn}), and satisfies N/2≦n<N/2:

$$\begin{matrix}{I}^{′} ( x , y ; {f}_{zn} ) = {\sum }_{j = 1}^{N} I ( x , y , {z}_{j} ) exp ( 2 π i {f}_{{z}_{n}} {z}_{j} ) & Expression 13 \\ {f}_{zn} = \frac{n}{{z}_{max} - {z}_{min} + Δ z} & Expression 14\end{matrix}$$

N denotes the number of captured images equal to or larger than two. Since I′(x,y;f_{zn}) becomes non-0 only in the region in which the Expression 10 is satisfied, the Expression 12 is identical to the series within in range of −n₀˜n₀ in Expression 15:

$$I ( x , y , z ) = {\sum }_{n = - {n}_{0}}^{{n}_{0}} {I}^{′} ( x , y ; {f}_{{z}_{n}} ) exp ( - 2 π i {f}_{{z}_{n}} z ) \qquad Expression 15$$

Herein, n₀ is a maximum of n that satisfies Expression 16:

$$n \leq ( {z}_{max} - {z}_{min} + Δ z ) \frac{1 - \sqrt{1 - {NA}^{2}} - \{ 1 - \sqrt{1 - {( NA ɛ )}^{2}} \}}{λ} \qquad Expression 16$$

The following expression is obtained by dividing both sides of the Expression 16 by (zₘₐₓ−zₘᵢₙ+Δz) based upon the Expression 14:

$${f}_{zn} \leq \frac{1 - \sqrt{1 - {NA}^{2}} - \{ 1 - \sqrt{1 - {( NA ɛ )}^{2}} \}}{λ} \qquad Expression 17$$

Expression 15 means that an image at an arbitrary focus position z can be estimated by finding a Fourier coefficient in accordance with the Expression 13 based upon the image data I(x,y,zⱼ) obtained at different focus positions and by linearly coupling exp(−2πif_{zn}z) utilizing the coefficient. In other words, an image can be estimated by linearly coupling the Fourier coefficient I′(x,y;f_{zn}) as the two-dimensional data.

A maximum value f_{zmax} of f_{zn} is determined by Expression 18 based upon the interval Δz of the acquired images based upon the sampling theorem:

$${f}_{{z}_{max}} = \frac{1}{2 Δ z} \qquad Expression 18$$

A folding noise is generated when f_{zmax} is smaller than the right side of the Expression 10 and the estimation accuracy of the image lowers. In order to precisely estimate the image, f_{zmax} needs to be larger than the right side of the Expression 10. Therefore, the condition of Δz is determined by Expression 19 based upon the Expressions 18 and 10:

$$\vert Δ z \vert \leq \frac{1}{2} \frac{λ}{1 - \sqrt{1 - {NA}^{2}} - \{ 1 - \sqrt{1 - {( NA ɛ )}^{2}} \}} \qquad Expression 19$$

As long as a width Δz by which an image is acquired is set within the range of the Expression 19, the image can be precisely estimated at an arbitrary focus position. The Expression 19 indicates that Δz when there is a center shield in the pupil can be made M times as large as that when there is no center shield. Herein, M is expressed by Expression 20:

$$M = \frac{1 - \sqrt{1 - {NA}^{2}}}{1 - \sqrt{1 - {NA}^{2}} - \{ 1 - \sqrt{1 - {( NA ɛ )}^{2}} \}} \qquad Expression 20$$

A spectrum of an image, such as an organism sample, a person, and a landscape, generally reduces as absolute values fₓ, f_{y}, and f_{z} increase. Therefore, for images acquired with Δz larger than the Expression 19, an image can be estimated if a certain error is permissible. In this case, Δz may be set previously or at the image pickup time based upon the image estimation precision required by the user.

While this embodiment discusses that there is the center shield in the pupil of the image pickup optical system, a similar effect can be expected when the center shield is arranged in a pupil of an illumination optical system.

The Expression 12 defines a Fourier series expansion only in the z direction but the Fourier series expansion in the x and y directions may be simultaneously performed as follows:

$$I ( {x}_{p} , {y}_{q} , z ) = {\sum }_{s = 1}^{{N}_{s}} {\sum }_{t = 1}^{{N}_{t}} {\sum }_{n = - {n}_{0}}^{{n}_{0}} {I}^{′} ( {f}_{{x}_{s}} , {f}_{{y}_{t}} , {f}_{{z}_{n}} ) exp [ - 2 π i ( {f}_{{x}_{s}} {x}_{p} + {f}_{{y}_{t}} {y}_{q} + {f}_{{z}_{n}} z ) ] \qquad Expression 21$$

A coefficient I′(fₓₛ,f_{yt},f_{zn}) is a Fourier coefficient calculated based upon I(xₚ,y_{q},zⱼ) and Expression 22:

$${I}^{′} ( {f}_{{x}_{s}} , {f}_{{y}_{t}} , {f}_{{z}_{n}} ) = {\sum }_{p = 1}^{{N}_{p}} {\sum }_{q = 1}^{{N}_{q}} {\sum }_{j = 1}^{N} I ( {x}_{p} , {y}_{q} , {z}_{j} ) exp [ 2 π i ( {f}_{{x}_{s}} {x}_{p} + {f}_{{y}_{t}} {y}_{q} + {f}_{{z}_{n}} {z}_{j} ) ] \qquad Expression 22$$

In comparison with the Expression 12, the Expression 21 is more complex and needs a longer computing time but a form of the Expression 21 is more advantageous when a low-pass filter is applied to the image processing.

A sinc function may be used as a function for the image estimation. In other words, the image may be calculated in accordance with Expression 23:

$$I ( x , y , z ) = {\sum }_{j = - ∞}^{∞} I ( x , y , {z}_{j} ) sinc [ B ( z - {z}_{j} ) ] \qquad Expression 23$$

The sinc function is a function expressed by sin(πx)/πx. B is a constant defined by Expression 24 and the interval Δz by which the images are obtained:

$$B = \frac{1}{Δ z} \qquad Expression 24$$

Although the Expression 23 is an infinite series, while only N pieces of image data is acquired and thus only a finite number of images are summed up. Accordingly, the Expression 23 is modified to Expression 25 on the assumption that the image is periodically repeated outside the range of z by which the images have been acquired. In this case, as illustrated in the following expression, the N pieces of image data are multiplied by sinc((z−zⱼ)/Δz) and summed up.

$$I ( x , y , z ) = {\sum }_{v = - {N}_{v}}^{{N}_{v}} {\sum }_{j = 1}^{N} I ( x , y , {z}_{j} - Tv ) sinc [ B ( z - Tv - {z}_{j} ) ] \qquad Expression 25$$

Herein, T is a cycle by which the image is repeated in the z direction and expressed by T=zₘₐₓ−zₘᵢₙ+Δz. Nᵥ is an integer equal to or larger than 0, and its value can be arbitrarily set by the user.

The image estimating method utilizes the Fourier series expansion expressed by the Expression 12, but the series expansion is not limited to the Fourier series expansion. A cosine transform may be used for the estimation. The method will be briefly described.

In the method of using the cosine transform, a discrete cosine transform expressed by Expression 26 is used to find an expansion coefficient I′(x,y;f_{zn}) for I(x,y,z) and a spatial frequency f_{zn} is obtained according to the Expression 14:

$${I}^{′} ( x , y , {f}_{zn} ) = w ( n ) {\sum }_{j = 1}^{N} I ( x , y , {z}_{j} ) cos ( π {f}_{zn} ( {z}_{j} + \frac{Δ z}{2} ) ) \\ w ( n ) = \begin{matrix}\frac{1}{\sqrt{N}} & n = 0 \\ \sqrt{\frac{2}{N}} & n \neq 0\end{matrix} \qquad Expression 26$$

Unlike the above method of using the Fourier series expansion, n is set to an integer that satisfies 0≦n≦N−1. The found I′(x,y;f_{zn}) is linearly coupled in accordance with Expression 27, and an image can be calculated at the position z.

$$I ( x , y , z ) = {\sum }_{n = 1}^{N} w ( n ) {I}^{′} ( x , y ; {f}_{zn} ) cos ( π {f}_{zn} ( z + \frac{Δ z}{2} ) ) \qquad Expression 27$$

When the cosine transform is used, the condition corresponding to the Expression 17 is expressed as follows since a coefficient in the parenthesis of cos expressed in the Expression 27 is different from that in the parentheses of exp in the Expression 12 by 2:

$${f}_{zn} \leq \frac{2 [ 1 - \sqrt{1 - {NA}^{2}} - \{ 1 - \sqrt{1 - {( NA ɛ )}^{2}} \} ]}{λ} \qquad Expression 28$$

The Expression 27 is equivalent with Expression 29 by applying the discussion made in the derivation of the Expression 15 where n₀ is a maximum of n that satisfies the Expression 28:

$$I ( x , y , z ) = {\sum }_{n = 1}^{{n}_{0}} w ( n ) {I}^{′} ( x , y ; {f}_{zn} ) cos ( π {f}_{zn} ( z + \frac{Δ z}{2} ) ) \qquad Expression 29$$

An image can be estimated at arbitrary z according to the above procedure.

The expressions used for the image estimation are not limited to the Expressions 26 and 27. The method according to this embodiment covers a similar conversion utilizing cos or sin.

### First Embodiment

A description will now be given of an image estimating method at an arbitrary focus position according to a first embodiment. Images of the object acquired according to the flowchart in FIG. 3 are illustrated by simulation. Assume that the image pickup optical system has a numerical aperture of 0.7, an imaging magnification is 10 times, light is monochromatic and has a wavelength of 550 nm, the image pickup optical system has a circular center shield, and a radius of the circular shield is 30% as large as the pupil diaphragm. A partial coherent illumination is used, and an effective light source has an annular shape. Also, assume that NAᵢ/NA=0.7 and NAᵢ_{_{—}}ᵢₙ/NA=0.3 where NA is a numerical aperture of the image pickup optical system on the object side, NAᵢ is a numerical aperture of the illumination optical system, and NAᵢ_{_{—}}ᵢₙ is a numerical aperture for the center shield of the effective optical source.

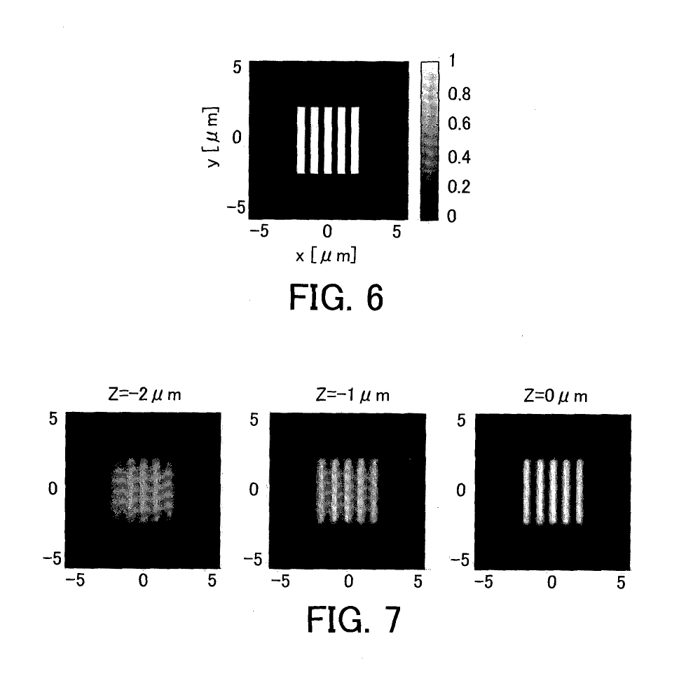

FIG. 6 illustrates an amplitude transmittance of the object. A line chart having a width of 0.5 μm in the y direction is used for the object. The object is assumed to be a two-dimensional object according to calculations. Of course, this method is applicable to an object having a thickness. A focus position is changed every 1.0 μm from −4 μm (zₘᵢₙ) to 4 μm (zₘₐₓ). FIG. 7 illustrates examples of images obtained with z=2 μm, −1 μm, and 0 μm. Ordinate and abscissa axes in FIG. 7 indicate coordinates on the object side.

A description will now be given of the image estimating method. I(x,y,z) denotes a brightness distribution of an image at a focus position z. A discrete Fourier transform as a frequency conversion in the z direction is performed for I(x,y,z) according to the Expression 13, and I′(x,y;f_{z}) as converted N pieces of image data is acquired (image converting step). Moreover, a frequency f_{zn} is calculated for a plurality of pieces of converted image data in accordance with the Expression 14 and zₘₐₓ and zₘᵢₙ (frequency calculating step).

Next, a focus position z to be observed is designated. For example, z=−1.5 μm and z=−0.5 μm are designated. These values are substituted for the Expression 12 and the Expression 12 is calculated. In other words, the N pieces of converted image data is multiplied by a complex number determined by f_{zn} and z and summed up (coupling step).

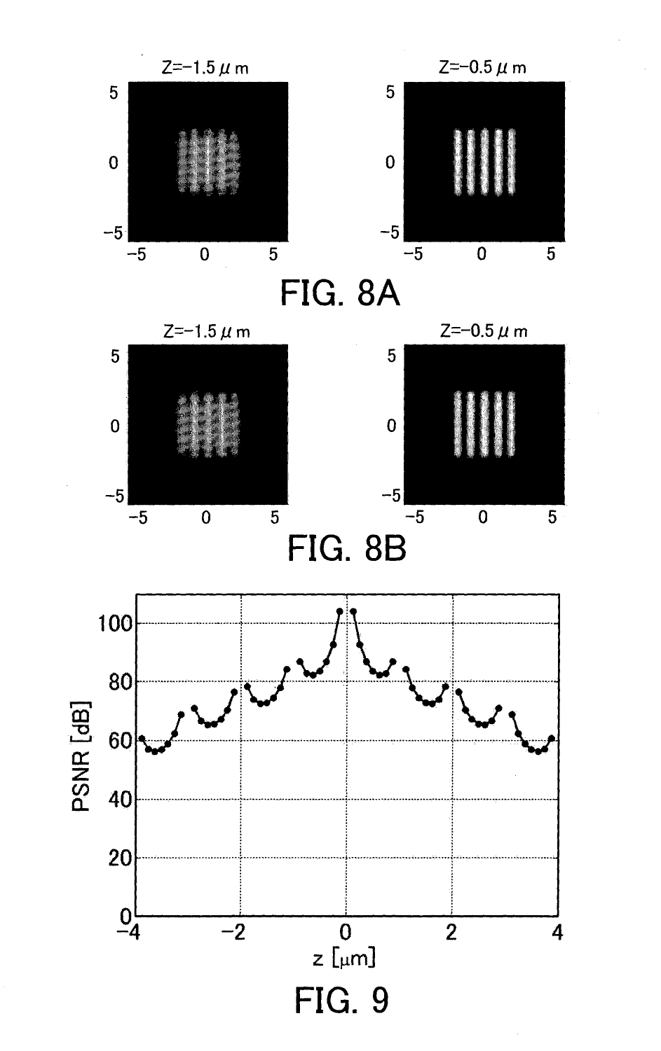

FIG. 8A illustrates obtained images. FIG. 8B illustrates images obtained without estimations for comparison purposes. When they are compared with each other, there is no visually confirmed difference. PSNR (Peak Signal to Noise Ratio) is calculated to quantify the difference of the image. The PSNR is a value calculated by the Expressions 30 and 31, and quantifies the similarity of the image. It has a value equal to or larger than 0, and the similarity of the image is higher as the value increases. In general, an image with a PSNR larger than 35 dB is considered to be a high-quality image.

$$\begin{matrix}P S N R ( z ) = 10 {log}_{10} ( \frac{{255}^{2}}{M S {E ( z )}^{2}} ) & Expression 30 \\ M S E ( z ) = \sqrt{\frac{{\sum }_{p}^{{N}_{p}} {\sum }_{q}^{{N}_{q}} {( I ( {x}_{p} , {y}_{q} , z ) - {I}_{est} ( {x}_{p} , {y}_{q} , z ) )}^{2}}{{N}_{p} {N}_{q}}} & Expression 31\end{matrix}$$

Herein, Iₑₛₜ(x,y,z) is estimated image data. Expression 30 corresponds to an 8-bit image.

FIG. 9 is a graph illustrating a relationship between an estimated focus position z [μm] (abscissa axis) and PSNR [dB] (ordinate axis). The focus position is changed every 0.125 μm from −4 μm to 4 μm and estimated, although actually obtained images are removed. It is understood that the PSNR is higher than 35 dB in the overall estimated range and the estimated image well reproduces the actually obtained images.

A spectrum of an image, such as an organism sample, a person, and a landscape, generally reduces as absolute values fₓ, f_{y}, and f_{z} increase. According to this fact, the image can be estimated with a high precision even when Δz is made larger than λ/2(1−(1−NA²)^{1/2}). This result will be described in the seventh embodiment.

This embodiment assumes the light is monochromatic and having a wavelength of 550 nm from the object but the light is not limited to this embodiment. For example, a plurality of light emitting diodes may be utilized for the illumination and photography with multicolor light or a halogen lamp may be utilized for the illumination and photography with wide-spread illumination light. The wavelength used herein may contain a wavelength range for organism imaging and general photography, such as 300 nm˜1500 nm. In this case, the image sensor also may respond to the above wavelength range. Moreover, the image pickup apparatus may acquire the spectrum data of the wavelength range.

This embodiment sets an imaging magnification of the image pickup apparatus to 10 times but the imaging magnification is not limited to this value. For example, a reduction optical system may be used. A situation where the image pickup optical system is a reduction optical system and the illumination optical system is an incoherent system corresponds to the general camera photography. In other words, the present invention is applicable to the general camera photography.

This embodiment assumes, but is not limited to, no aberrations. This inventor has confirmed that this embodiment is applicable to the optical system having an aberration. This embodiment does not provide image processing, such as a noise reduction or image stabilization, for the obtained image, but such image processing may be performed. This embodiment discusses, but is not limited to, images obtained at regular intervals.

The frequency calculation step is not limited to the one of calculating f_{zn} in accordance with the Expression 14.

This embodiment discusses, but is not limited to, images obtained at positions zⱼ that are spaced at regular intervals Δz. In the actual measurement, the regular intervals are not necessarily obtained due to the driving error of the stage, etc., but this inventor has confirmed that this embodiment is applicable even to this case.

### Second Embodiment

A description will now be given of an image estimating method at an arbitrary focus position according to a second embodiment. Images of the object acquired according to the flowchart in FIG. 3 are illustrated by simulation. The calculation condition is the same as that of the first embodiment, and the obtained images are the same as those of FIG. 7. A three-dimension discrete Fourier transform is performed for the brightness distribution I(x,y,z) of the acquired image with respect to x, y, and z in accordance with the Expression 22 and I′(fₓ,f_{y},f_{z}) is acquired. The estimated image is calculated in accordance with the Expression 21 utilizing I′(fₓ,f_{y},f_{z}). The estimated focus position is the same as that of the first embodiment.

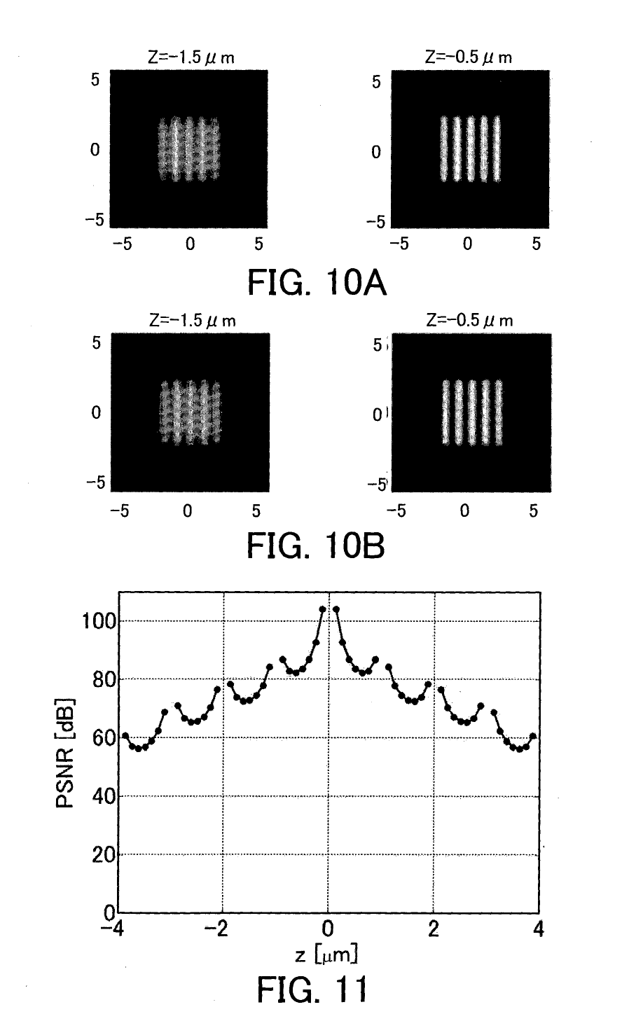

FIG. 10A illustrates examples of the estimated images. FIG. 10B illustrates images obtained without estimations for comparison purposes. When they are compared with each other, there is no visually confirmed difference. The PSNR is calculated to quantify the difference of the image.

FIG. 11 is a graph illustrating a relationship between an estimated focus position z [μm] (abscissa axis) and PSNR [dB] (ordinate axis). The estimated focus position is similar to that of the first embodiment, and actually obtained images are removed. It is understood that the PSNR is higher than 35 dB in the overall estimated range and the estimated image well reproduces the actually obtained images. Moreover, it is confirmed that even when Δz is increased up to a value that is 1.5 times as large as λ/2(1−(1−NA²)^{1/2}), a sufficient image quality can be secured.

The second embodiment performs a Fourier transform with respect to x and y and needs a longer computing time but it may be properly used when image processing, such as a noise reduction, is simultaneously performed. As a noise reduction, a method for applying a low-pass filter to an image is known. The method can be realized by multiplying a spectrum of an image by a filter of attenuating a high frequency component. The second embodiment performs the Fourier transform with respect to x and y in finding the spectrum of the image, and thus removes a noise in the image estimation.

### Third Embodiment

A description will now be given of an image estimating method at an arbitrary focus position according to a third embodiment. Images of the object acquired according to the flowchart in FIG. 3 are illustrated by simulation. The calculation condition is the same as that of the first embodiment, and the obtained images are the same as those of FIG. 7.

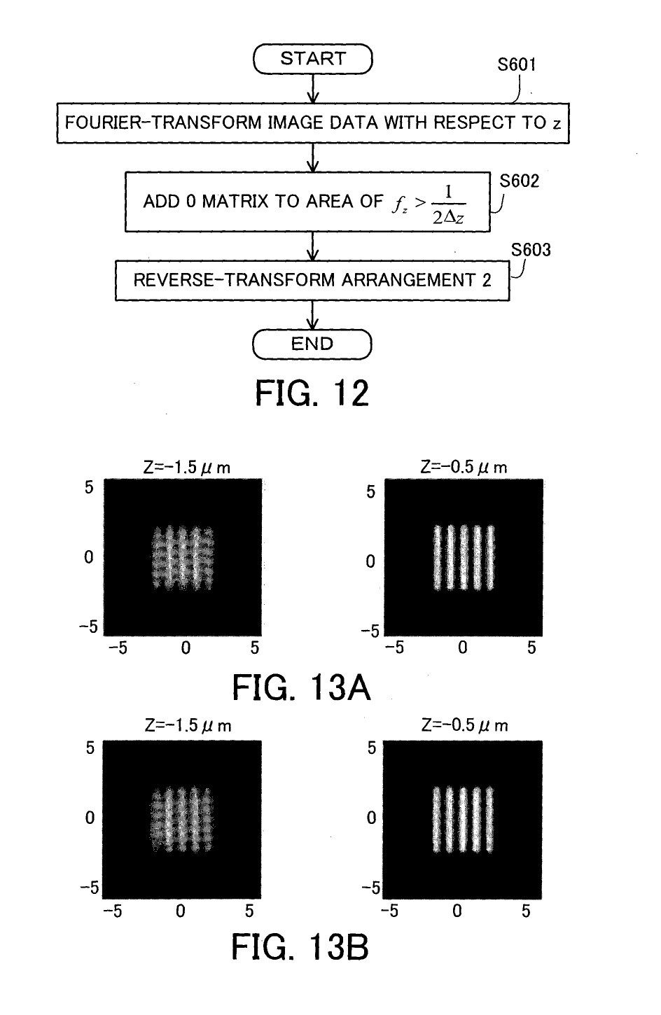

The third embodiment estimates an image in accordance with a flowchart illustrated in FIG. 12. A discrete Fourier transform (frequency conversion) is performed for obtained image data in z in accordance with the Expression 13 in S601, and converted image data is obtained (image converting step). Next, 0 matrix (0 value) is added to the converted image data obtained in S602 in a region of |f_{z}|>½Δz (a higher frequency range than a maximum value of the frequency f_{zn} and a lower frequency range than a minimum value) so as to expand the converted image data. This expanding is called zero padding (zero padding step). An inverse Fourier transform (reverse frequency conversion) is performed for zero-padded data in S603 with respect to f_{z} (inverse frequency converting step).

The frequency conversion in the image converting step may utilize the Fourier transform or the inverse Fourier transform. The frequency calculating step calculates f_{zn} in accordance with the Expression 14. As discussed, the image is reproduced at regular intervals smaller than the obtained Δz. S601 and S603 can accelerate a calculation by using an algorithm of the fast Fourier transform.

FIG. 13A illustrates examples of the estimated images. FIG. 13B illustrates images obtained without estimations for comparison purposes. When they are compared with each other, there is no visually confirmed difference. The PSNR is calculated to quantify the difference of the image.

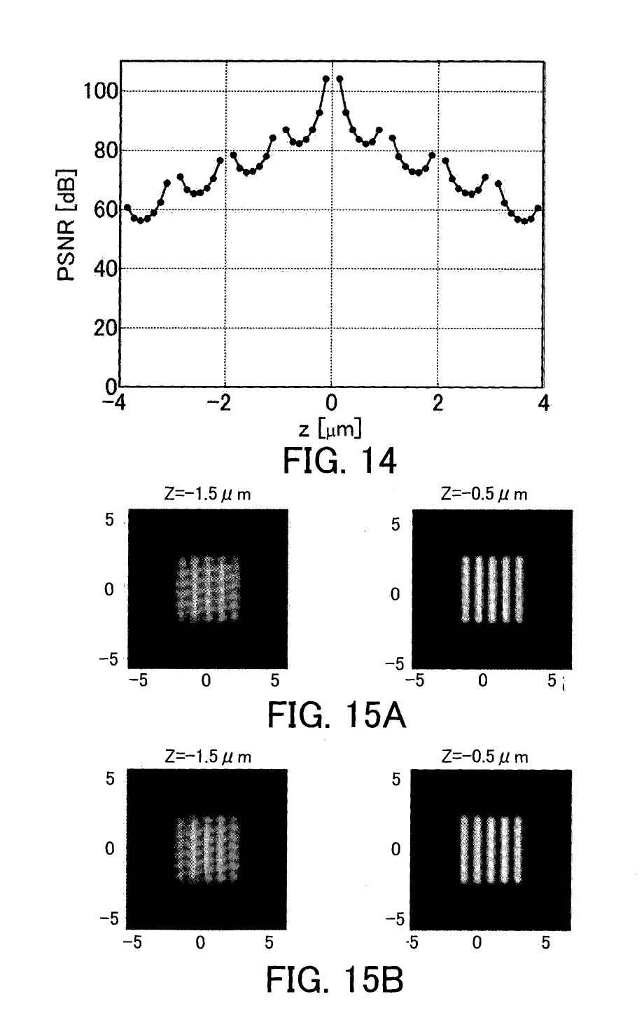

FIG. 14 is a graph illustrating a relationship between an estimated focus position z [μm] (abscissa axis) and PSNR [dB] (ordinate axis). The estimated focus position is similar to that of the first embodiment, and actually obtained images are removed. It is understood that the PSNR is higher than 35 dB in the overall estimated range and the estimated image well reproduces the actually obtained images.

Moreover, it is confirmed that even when Δz is increased up to a value that is 1.5 times as large as λ/2(1−(1−NA²)^{1/2}), a sufficient image quality can be secured.

As described above, an image can be estimated at a focus position at which no image is captured. The third embodiment can generate a plurality of estimated images through fast inverse Fourier transform, and thus is suitable for an observation of an xz section.

### Fourth Embodiment

A description will now be given of an image estimating method at an arbitrary focus position according to a fourth embodiment. Images of the object acquired according to the flowchart in FIG. 3 are illustrated by simulation. The calculation condition is the same as that of the first embodiment, and the obtained images are the same as those of FIG. 7.

The fourth embodiment also estimates an image in accordance with the flowchart illustrated in FIG. 12. The fourth embodiment performs a discrete Fourier transform for three coordinates of x, y, and z in S601, and an inverse Fourier transform for three coordinates of fₓ, f_{y}, and f_{z} in S603.

FIG. 15A illustrates examples of the estimated images. FIG. 15B illustrates images obtained without estimations for comparison purposes. When they are compared with each other, there is no visually confirmed difference. The PSNR is calculated to quantify the difference of the image.

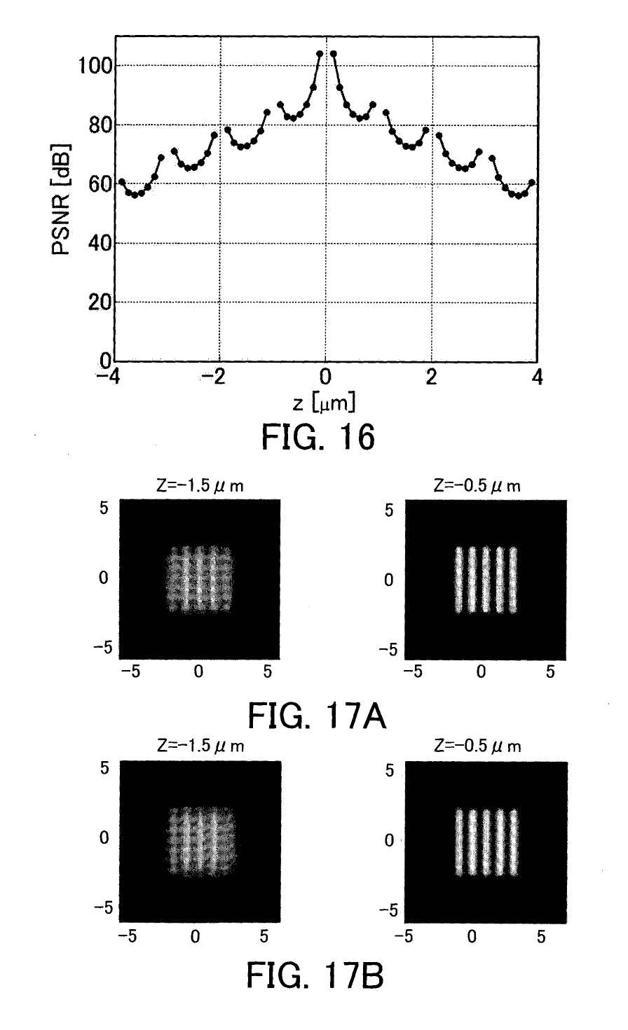

FIG. 16 is a graph illustrating a relationship between an estimated focus position z [μm] (abscissa axis) and PSNR [dB] (ordinate axis). The estimated focus position is similar to that of the first embodiment, and actually obtained images are removed. It is understood that the PSNR is higher than 35 dB in the overall estimated range and the estimated image well reproduces the actually obtained images.

Moreover, it is confirmed that even when Δz is increased up to a value that is 1.5 times as large as λ/2(1−(1−NA²)^{1/2}), a sufficient image quality can be secured.

The fourth embodiment generates a plurality of estimated images at one time utilizing an inverse Fourier transform, and thus is properly used for an observation of the xz section. The fourth embodiment performs a Fourier transform with respect to x and y and needs a longer computing time but it may be properly used when image processing, such as a noise reduction, is simultaneously performed. As a noise reduction, a method for applying a low-pass filter to an image is known. The method can be realized by multiplying a spectrum of an image by a filter of attenuating a high frequency component. The fourth embodiment performs the Fourier transform with respect to x and y in finding the spectrum of the image, and thus removes a noise in the image estimation.

### Fifth Embodiment

A description will now be given of an image estimating method at an arbitrary focus position according to a fifth embodiment. Images of the object acquired according to the flowchart in FIG. 3 are illustrated by simulation. The calculation condition is the same as that of the first embodiment, and the obtained images are the same as those of FIG. 7.

The estimated image is calculated in accordance with the Expression 25 utilizing the brightness distribution I(x,y,z) of the obtained image. The estimated focus position is the same as that of the first embodiment, and Nᵥ=2 is set. FIG. 17A illustrates examples of the estimated images. FIG. 17B illustrates images obtained without estimations for comparison purposes. When they are compared with each other, there is no visually confirmed difference. The PSNR is calculated to quantify the difference of the image.

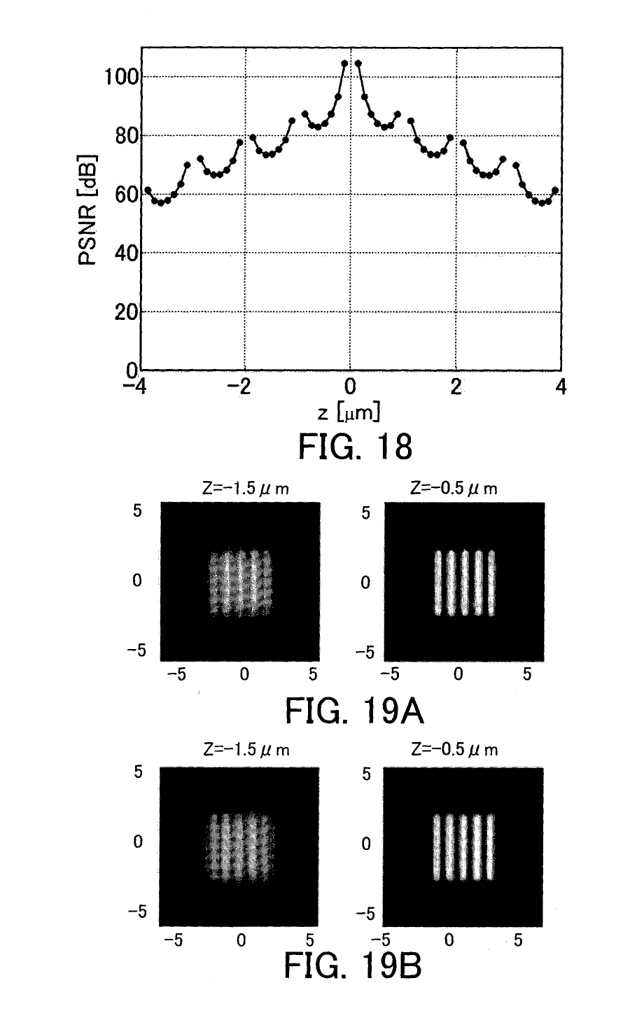

FIG. 18 is a graph illustrating a relationship between an estimated focus position z [μm] (abscissa axis) and PSNR [dB] (ordinate axis). The estimated focus position is similar to that of the first embodiment, and actually obtained images are removed. It is understood that the PSNR is higher than 35 dB in the overall estimated range and the estimated image well reproduces the actually obtained images.

Moreover, it is confirmed that even when Δz is increased up to a value that is 1.5 times as large as λ/2(1−(1−NA²)^{1/2}), a sufficient image quality can be secured. The fifth embodiment does not employ the Fourier transform and can estimate the image at a higher speed.

### Sixth Embodiment

A description will now be given of an image estimating method at an arbitrary focus position according to a sixth embodiment. Images of the object acquired according to the flowchart in FIG. 3 are illustrated by simulation. The calculation condition is the same as that of the first embodiment, and the obtained images are the same as those of FIG. 7. A discrete cosine transform is performed for the brightness distribution I(x,y,z) of the acquired image with respect to z in accordance with the Expression 26 and I′(fₓ,f_{y},f_{z}) is acquired. The estimated image is calculated in accordance with the Expression 27 utilizing I′(fₓ,f_{y},f_{z}). The estimated focus position is the same as that of the first embodiment.

FIG. 19A illustrates examples of the estimated images. FIG. 19B illustrates images obtained without estimations for comparison purposes. When they are compared with each other, there is no visually confirmed difference. The PSNR is calculated to quantify the difference of the image.

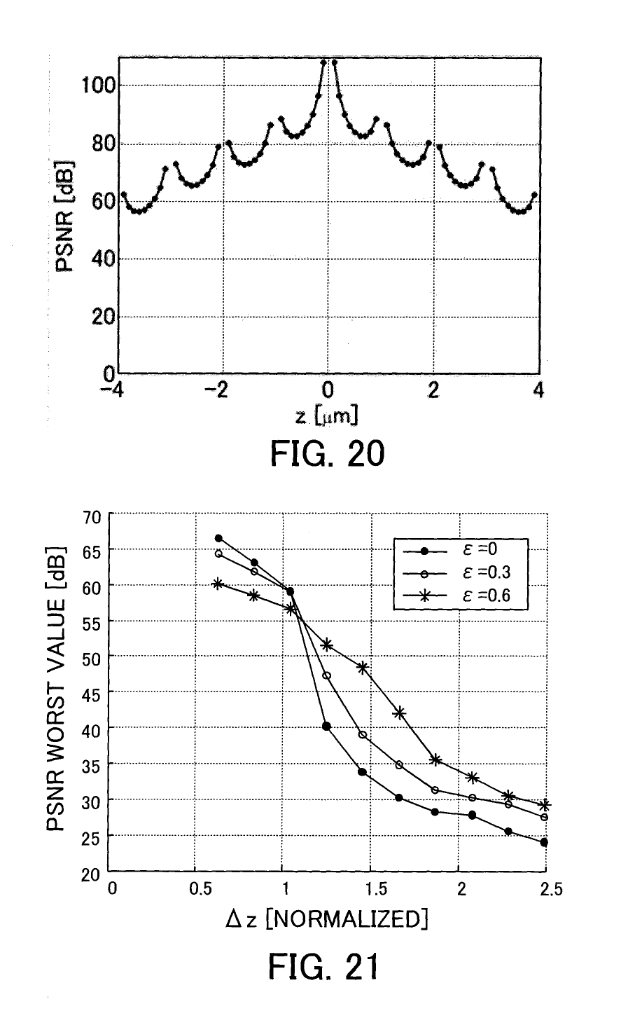

FIG. 20 is a graph illustrating a relationship between an estimated focus position z [μm] (abscissa axis) and PSNR [dB] (ordinate axis). The estimated focus position is similar to that of the first embodiment, and actually obtained images are removed. It is understood that the PSNR is higher than 35 dB in the overall estimated range and the estimated image well reproduces the actually obtained images. Moreover, it is confirmed that even when Δz is increased up to a value that is 1.5 times as large as λ/2(1−(1−NA²)^{1/2}), a sufficient image quality can be secured.

The sixth embodiment employs a cosine transform as a frequency converting method relating to z in the sixth embodiment. Since the cosine transform is computable in the real number, the used memory capacity is smaller than that for the method using the Fourier transform. Even when a difference between I(x,y,zₘᵢₙ) and I(x,y,zₘₐₓ) is large, for example, even when the optical system has a large aberration, an image can be estimated with a high accuracy.

### Seventh Embodiment

A description will now be given of an image estimating method at an arbitrary focus position according to a seventh embodiment. A description will be given of a relationship between the image obtaining interval and estimation accuracy, and an effect of a center shield arranged in the pupil of the image pickup optical system. In this case, a light intensity has a lower area near a central part of a pupil plane than a periphery in the illumination optical system.

Images of the object acquired according to the flowchart in FIG. 3 are illustrated by simulation. As a calculation condition, assume that the image pickup optical system has a numerical aperture of 0.7, an imaging magnification is 10 times, monochromatic light has a wavelength of 550 nm, the image pickup optical system has a circular center shield, and a radius of the circular shield is ε times as large as the pupil diaphragm. ε has a value from 0 to 1, and E=0 means that there is no center shield. A partial coherent illumination is used, and an effective light source has an annular shape. Also, assume that NAᵢ/NA=0.7 where NAᵢ is a numerical aperture of the illumination optical system, and NA is a numerical aperture of the image pickup optical system on the object side. Under the above condition, the image of the object illustrated in FIG. 6 is found by a simulation. A focus position by which an image is obtained ranges from −8 μm (zₘᵢₙ) to 8 μm (zₘₐₓ), and an image obtaining interval is Δz. An image at a position z is estimated based upon the objected images and the method illustrated in the first embodiment. Z used for the estimation is designated every 0.1 μm from −8 μm (zₘᵢₙ) to 8 μm (zₘₐₓ). The PSNR is calculated so as to compare the image estimated at each z with the image obtained without estimation. The worst value (ordinate axis) is extracted from the obtained PSNR, and a graph that indicates the value for the obtaining interval Δz (abscissa axis) is FIG. 21. In FIG. 21, Δz is normalized by λ/2(1−(1−NA²)^{1/2}) A result with a different ε is distinguished with a different mark.

Initially, assume ε=0. As Δz increases, the PSNR decreases. This means that the estimated error increases as the obtaining interval increases. In obtain an image, Δz may be set based upon the relationship between Δz and PSNR illustrated in FIG. 21 so as to satisfy the precision target required by the user. For example, Δz may be set equal to or smaller than 1.4 so that the image can have a PSNR of 35 dB or higher. When it is converted into a non-normalized size, Δz may be set equal to or smaller than 1.4×λ/2(1−(1−NA²)^{1/2}).

From FIG. 21, as ε increases, the attenuation of the PSNR worst value becomes moderate for Δz. In other words, as the center shield arranged in the pupil of the image pickup optical system becomes larger, the estimated precision can be maintained high even when Δz increases.

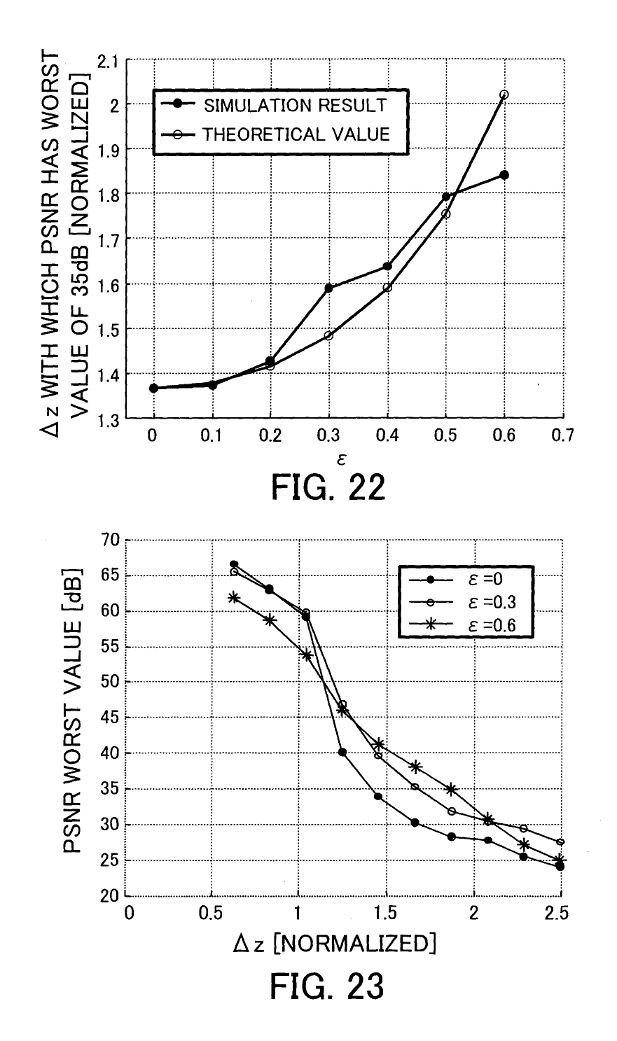

Now consider a permissible range of Δz. FIG. 22 illustrates a relationship between Δz (ordinate axis) by which the worst value of PSNR becomes 35 and ε (abscissa axis). The theoretically expected value of FIG. 22 is the result of multiplying a value at ε=0 by M illustrated by the Expression 20. From FIG. 22, as ε increases, Δz (ordinate axis) by which the worst value of PSNR becomes 35 increases. In other words, as the center shield of the pupil in the image pickup optical system increases, Δz by which the estimated error falls in the permissible value increases. In addition, the theoretically expected value almost reproduces the simulation result. From the fact that a permissible range of Δz at ε=0 is equal to or smaller than 1.4×λ/2(1−(1−NA²)^{1/2}), a permissible range of Δz at ε≠0 is given by Expression 32.

$$\vert Δ z \vert \leq 1.4 \times \frac{1}{2} \frac{λ}{1 - \sqrt{1 - {NA}^{2}} - ( 1 - \sqrt{1 - {( NA ɛ )}^{2}} )} \qquad Expression 32$$

This expression contains ε=0.

### Eighth Embodiment

A description will now be given of an image estimating method at an arbitrary focus position according to an eighth embodiment. In the eighth embodiment, a description will be given of an effect of arranging a center shield in the pupil of the illumination optical system or an annular effective light source.

Images of the object acquired according to the flowchart in FIG. 3 are illustrated by simulation. As a calculation condition, assume that the image pickup optical system has a numerical aperture of 0.7, an imaging magnification is 10 times, light is monochromatic and has a wavelength of 550 nm, and the pupil is circular. A partial coherent illumination is used, and an effective light source has an annular shape due to the center shield arranged in the pupil of the illumination optical system. Also, assume that NAᵢ/NA=0.7 where NAᵢ is the numerical aperture of the illumination optical system, NA is a numerical aperture of the image pickup optical system on the object side, and ε is a numerical aperture to the center shield.

Under the above condition, the image of the object illustrated in FIG. 6 is found by a simulation. The range of the focus position used to obtain the image, the obtaining interval Δz, and the estimated position z are the same as those of the seventh embodiment. Moreover, similar to the seventh embodiment, the PSNR is calculated so as to compare the image estimated at each z with the image obtained without estimation. The worst value (ordinate axis) is extracted from the obtained PSNR, and a graph that indicates the value for the obtaining interval Δz (abscissa axis) is FIG. 23. In FIG. 23, Δz is normalized by λ/2(1−(1−NA²)^{1/2}). A result with a different ε is distinguished with a different mark.

From FIG. 23, as ε increases, the attenuation of the PSNR worst value becomes moderate for Δz. In other words, as the center shield arranged in the pupil of the image pickup optical system becomes larger, the estimated precision can be maintained high even when Δz increases.

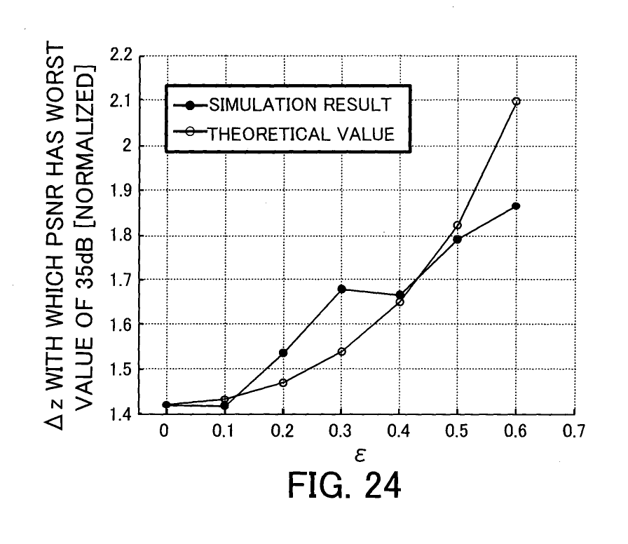

Now consider a permissible range of Δz. FIG. 24 illustrates a relationship between Δz (ordinate axis) by which the worst value of PSNR becomes 35 and ε (abscissa axis). The theoretically expected value of FIG. 22 is the result of multiplying a value at E=0 by M illustrated by the Expression 20. From FIG. 24, as ε increases, Δz (ordinate axis) by which the worst value of PSNR becomes 35 increases. In other words, as the center shield of the pupil in the image pickup optical system increases, Δz by which the estimated error falls in the permissible value increases. In addition, the theoretically expected value almost reproduces the simulation result. From the fact that a permissible range of Δz in ε=0 is equal to or smaller than 1.4×λ/2(1−(1−NA²)^{1/2}), a permissible range of Δz at ε≠0 is given by the Expression 32.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The image pickup apparatus to which the present invention is applied may be a microscope configured to obtain enlarged image data of an object, or a camera configured to obtain reduced image data of an object. A wavelength range by which the image pickup apparatus obtains the image data may be included in a range from 300 nm to 1500 nm, and a wavelength of the illumination light used to illuminate the object may be included in a range from 300 nm to 1500 nm.

### Ninth Embodiment

A description will now be given of an operation of network devices 460, 462, 464, and 466 (represented by “460” hereinafter) connected to the image estimating apparatus via the network 450 in designating the display position z. Since a user cannot immediately enter the display position z from the network device 460, it is initially necessary to confirm the image data so as to determine the display position z. Therefore, the network device 460 serves to designate (input) the position z and to receive image data, and includes or is connected to an image display unit, such as a display.

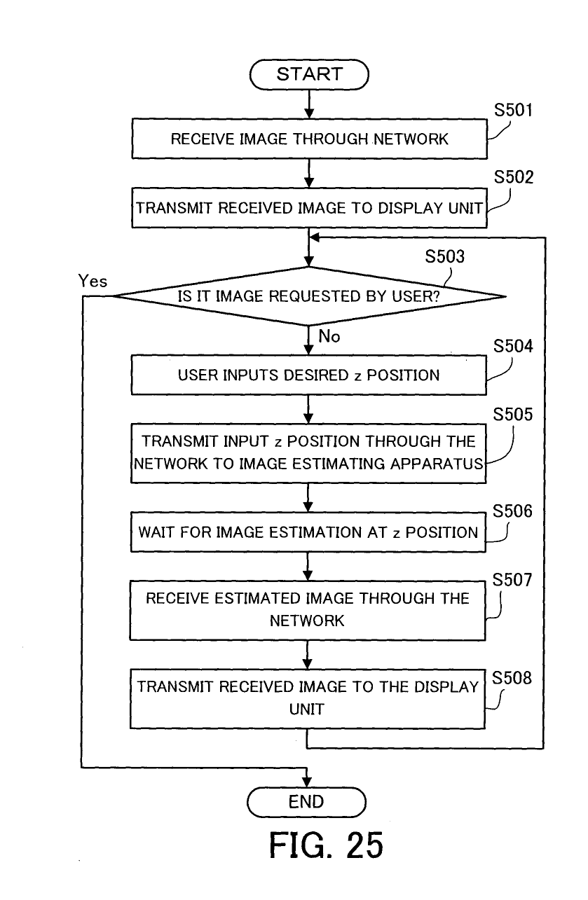

FIG. 25 illustrates a flowchart of an operation of the network device 460 according to this embodiment. This flowchart may be installed as an application program in the network 460 or in the image estimating apparatus or a server so that the network device 460 accessing it can execute can execute the program.

Initially, the user operates the network device 460 and accesses the image estimating apparatus or the server (not illustrated) via the network 450. The server (not illustrated) is connected to a storage (not illustrated). In this case, the image estimating apparatus does not store the image data, the storage stores the image data used for the estimation, and the image estimating apparatus obtains the image data used for the estimation from the storage. When the network device 460 accesses the image estimating apparatus, the storage configured to store the image data used for the estimation is connected to the image estimating apparatus directly or via a network, such as a LAN. Now assume that the network device 460 accesses the information processing unit 400 as the image estimating apparatus.

When accessing the information processing unit 400, the network device 460 is requested to enter the user name and a password for authentication.

The authenticated user, such as a medical doctor, accesses information of a patient stored in the data storage 403 by inputting the ID of the patient. The data storage 403 stores N pieces of image data of the object (patient) obtained using an image pickup apparatus having an image pickup optical system, at different positions zⱼ (1≦j≦N) determined by the interval Δz in the optical axis direction of the image pickup apparatus where N is an integer of 2 or larger. Accordingly, the user selects at least one of the N pieces of image data based upon thumbnails or file names. Thereafter, the user views the image on the network, or downloads and stores it, or selects another image, in accordance with the menu selection. The image to be obtained may be one of images sequentially sent from the list. The user may select a previously estimated image.

Herein, the user selects the download of the image data in the network device 460, and acquires the image (S501). If necessary, the network device 460 may be once disconnected from the information processing unit 400 via the network.

The network device 460 then displays the received image data on the display unit (S502). As a result, the user can confirm the image displayed on the display unit. If the displayed image is worthy for the diagnoses (Yes of S503), the following operation becomes unnecessary. When the image data is displayed, a folder ID of the N pieces of image data and a file ID of the image data that is being viewed are also displayed.

In general, the displayed image is not necessarily focused upon the desired part (No of S503). Therefore, the network device 460 again accesses the information processing unit 400, is authenticated, displays or downloads another stored image data. However, an estimation button of the image data is clicked from the menu unless there is image data at the z position.

Then, the display unit of the network device 460 displays a menu that prompts a user to input the folder ID of the N pieces of image data or to select it by searching for the patient ID. When the user designates the folder of the N pieces of image data via the designating unit of the network device, the display unit of the network device 460 displays a menu that prompts a user to select the closest one or two out of the N captured images to the target image (s). For example, when the user attempts to obtain image data between the two pieces of image data and selects the two pieces of image data, the thumbnail or file name of the image data and their zⱼ positions are displayed. In that case, the display unit of the network device 460 may display information of a range of the z position that can be input (such as, minimum value zₘᵢₙ≦z≦maximum value zₘₐₓ).

Next, the user inputs a desired z position. In the step of designating the z position, the user inputs the position between the two zⱼ positions as a candidate of the desired z position through the designating unit of the network device 460, (S504), presses the “Enter” key, and transmits it to the image estimating apparatus (S505). In that case, the network device 460 may display an error message if the input z position exceeds the maximum value zₘₐₓ or minimum value zₘᵢₙ. It may also display an error message when the input z position is not located between the two pieces image data. Alternatively, when the user selects two pieces of image data, the z position between the two points may be automatically determined by calculating an average value of the two zⱼ position. When the user selects one piece of image data and enters the z position, the display unit may display that the entered z position is closer to or goes beyond the next zⱼ position. It may additionally display whether the next image data is to be displayed (with the zⱼ position) or whether the z position is to be changed.

The network device 460 stands by until the image estimating apparatus completes the estimation of the image (S506). When the image estimation ends, the network device 460 receives the estimated image through the network 450 (S507) and displays it on the display unit (S508). If the user observes the displayed image, and completes the processing if it is the desired image (Yes of S503). If the user seeks an image at another z position (No of S503), the procedure from S504 to S508 is repeated. In this case, two images may be either the currently estimated image data or the previously estimated image data. The network device 460 provides an image at a z position which the user requests, in accordance with the above flow.

This application claims the benefit of Japanese Patent Application No. 2012-112227, filed on May 16, 2012 which is hereby incorporated by reference herein in its entirety.

### INDUSTRIAL APPLICABILITY

The image estimating method according to the present invention is applicable to an image pickup apparatus configured to obtain an image of a sample utilizing an illumination optical system, an image pickup optical system, and a digital sensor, and more particularly to a digital microscope and a digital camera.

### REFERENCE SIGNS LIST

103 object
104 (image pickup) optical system
105 image sensor (photoelectric converter)
400 information processing unit (image estimating apparatus)
401 computer (operating unit)
450 network
460-464 network apparatus

1. An image estimating method configured to utilize an operating unit and image data of an object captured by an image pickup apparatus that includes an image pickup optical system, at N different positions zⱼ (1≦j≦N) that are spaced from each other at an interval Δz in an optical axis direction of the image pickup optical system, and to estimate image data at a position z (zₘᵢₙ≦z≦zₘₐₓ) in the optical axis direction, N being an integer of 2 or larger, zₘᵢₙ being a minimum value of z, and zₘₐₓ being a maximum value of z, the image estimating method comprising the steps of:
an image converting step of performing a frequency conversion for N pieces of image data in the optical axis direction, and of calculating N pieces of converted image data; and
a coupling step of multiplying the N pieces of converted image data by a complex number determined for the N pieces of converted image data based upon zₘᵢₙ, zₘₐₓ, z and Δz, and of summing up multiplied results.

2. The image estimating method according to claim 1, wherein the frequency conversion is a Fourier transform or an inverse Fourier transform,
wherein the image estimating method further comprises a frequency calculating step of calculating a frequency f_{zn} corresponding to the N pieces of converted image data based upon zₘᵢₙ, zₘₐₓ, and Δz, and
wherein the frequency calculating step calculates the frequency f_{zn} utilizing the following expression and the complex number is exp(−2πif_{zn}z) or exp(2πif_{zn}z) where i is an imaginary unit and n is an integer that satisfies the following expression:
$${f}_{zn} = \frac{n}{{z}_{max} - {z}_{min} + Δ z} \\ - \frac{N}{2} \leq n < \frac{N}{2} .$$

3. The image estimating method according to claim 1, further comprising:
a frequency calculating step of calculating a frequency f_{zn} corresponding to the N pieces of converted image data based upon zₘᵢₙ, zₘₐₓ, and Δz; and
a zero padding step of expanding the N pieces of converted image data by adding a 0 value to a higher frequency range than a maximum value of the frequency f_{zn} and to a lower frequency range than a minimum value of the frequency f_{zn},
wherein the combining step is an inverse frequency conversion step configured to perform an inverse frequency conversion corresponding to the frequency conversion for the image data expanded by the zero padding step in the optical axis direction.

4. The image estimating method according to claim 3, wherein the frequency conversion is a Fourier transform or an inverse Fourier transform, and
wherein the frequency calculating step calculates the frequency f_{zn} utilizing the following expression where n is an integer that satisfies the following expression:
$${f}_{zn} = \frac{n}{{z}_{max} - {z}_{min} + Δ z} \\ - \frac{N}{2} \leq n < \frac{N}{2} .$$

5. The image estimating method according to claim 3, wherein the frequency conversion contains a frequency conversion in a direction perpendicular to the optical axis, and
wherein the inverse frequency conversion contains an inverse frequency conversion corresponding to the frequency conversion in the direction perpendicular to the optical axis.

6. An image estimating method configured to utilize an operating unit and image data of an object captured by an image pickup apparatus that include an image pickup apparatus, at N different positions zⱼ (1≦j≦N) that are spaced from each other at an interval Δz in an optical axis direction of the image pickup optical system, and to estimate image data at a position z (zₘᵢₙ≦z≦zₘₐₓ) in the optical axis direction, N being an integer of 2 or larger, zₘᵢₙ being a minimum value of z, and zₘₐₓ being a maximum value of z, the image estimating method comprising the steps of multiplying N pieces of image data by sinc((z−zⱼ)/Δz) and by summing multiplied results up.

7. The image estimating method according to claim 1, wherein Δz satisfies the following expression where λ is a wavelength of light from the object, and NA is a numerical aperture of the image pickup optical system on an object side:
$$\vert Δ z \vert \leq 1.4 \times \frac{1}{2} \frac{λ}{1 - \sqrt{1 - {NA}^{2}}} .$$

8. The image estimating method according to claim 1, wherein Δz satisfies the following expression where λ is a wavelength of light from the object, and NA is a numerical aperture of the image pickup optical system on an object side:
$$\vert Δ z \vert \leq \frac{1}{2} \frac{λ}{( 1 - \sqrt{1 - {NA}^{2}} )}$$

9. The image estimating method according to claim 1, wherein the frequency conversion is a cosine transform,
wherein the image estimating method further comprises a frequency calculating step of calculating a frequency f_{zn} corresponding to the N pieces of converted image data based upon zₘᵢₙ, zₘₐₓ, and Δz,
wherein the frequency calculating step calculates the frequency f_{zn} utilizing the following expression where n is an integer that satisfies 0≦n≦N−1, and
$${f}_{zn} = \frac{n}{{z}_{max} - {z}_{min} + Δ z}$$
wherein the complex number is a real number determined by the following expression:
$$w ( n ) cos ( π {f}_{zn} ( z + \frac{Δ z}{2} ) )$$
$$w ( n ) = \begin{matrix}1 / \sqrt{N} & n = 0 \\ \sqrt{2 / N} & n \neq 0\end{matrix}$$

10. The image estimating method according to claim 1, wherein a light intensity has a lower area near a central part of a pupil plane than a periphery in the image pickup optical system.

11. The image estimating method according to claim 10, wherein the area is circular, and
wherein Δz satisfies the following expression where NA is a numerical aperture of the image pickup optical system on an object side, a radius of the area is ε times as large as a radius of a pupil in the image pickup optical system, and λ is a wavelength of light from the object:
$$\vert Δ z \vert \leq 1.4 \times \frac{1}{2} \frac{λ}{1 - \sqrt{1 - {NA}^{2}} - \{ 1 - \sqrt{1 - {( NA ɛ )}^{2}} \}}$$

12. The image estimating method according to claim 10, wherein the area is circular, and
wherein Δz satisfies the following expression where NA is a numerical aperture of the image pickup optical system on an object side, a radius of the area is ε times as large as a radius of a pupil in the image pickup optical system, and λ is a wavelength of light from the object:
$$\vert Δ z \vert \leq \frac{1}{2} \frac{λ}{1 - \sqrt{1 - {NA}^{2}} - \{ 1 - \sqrt{1 - {( NA ɛ )}^{2}} \}}$$

13. The image estimating method according to claim 1, wherein the image pickup apparatus includes an illumination optical system configured to illuminate the object, and
wherein a light intensity has a lower area near a central part of a pupil plane than a periphery in the illumination optical system.

14. The image estimating method according to claim 13, wherein the area is circular, and
wherein Δz satisfies the following expression where NA is a numerical aperture of the image pickup optical system on an object side, a radius of the area is ε times as large as a radius of a pupil of the image pickup optical system, and λ is a wavelength of light from the object:
$$\vert Δ z \vert \leq 1.4 \times \frac{1}{2} \frac{λ}{1 - \sqrt{1 - {NA}^{2}} - \{ 1 - \sqrt{1 - {( NA ɛ )}^{2}} \}}$$

15. The image estimating method according to claim 13, wherein the area is circular, and
wherein Δz satisfies the following expression where NA is a numerical aperture of the image pickup optical system on an object side, a radius of the area is ε times as large as a radius of a pupil in the image pickup optical system, and λ is a wavelength of light from the object:
$$\vert Δ z \vert \leq \frac{1}{2} \frac{λ}{1 - \sqrt{1 - {NA}^{2}} - \{ 1 - \sqrt{1 - {( NA ɛ )}^{2}} \}}$$

16. An image estimating method configured to utilize an operating unit and image data of an object captured by an image pickup apparatus that includes an image pickup optical system, at N different positions zⱼ (1≦j≦N) that are spaced from each other at an interval Δz in an optical axis direction of the image pickup optical system, and to estimate image data at a position z (zₘᵢₙ≦z≦zₘₐₓ) in the optical axis direction, N being an integer of 2 or larger, zₘᵢₙ being a minimum value of z, and zₘₐₓ being a maximum value of z, the image estimating method comprising the step of performing a complex Fourier series expansion for I(x,y,z) in a range from −n₀ to n₀ so as to obtain estimated image data wherein a complex Fourier coefficient of the complex Fourier series expansion is determined by a discrete Fourier transform of I(x,y,zⱼ), where I(x,y,z) is a brightness distribution representative of the image data at the position z by a three-dimensional function that contains the optical axis direction and two directions orthogonal to the optical axis, I(x,y,zⱼ) is a brightness distribution representative of N pieces of image data of the object, f_{zn} is a discrete spatial frequency in the optical axis direction and expressed as f_{zn}=n/(zₘₐₓ−zₘᵢₙ+Δz), n is an integer that satisfies −N/2≦n<N/2, NA is a numerical aperture of the image pickup optical system on an object side, λ is a wavelength of light from the object, n₀ is a maximum of n that satisfies the following expression, a radius of a circular shield is ε times as large as a radius of a pupil of the image pickup optical system when there is the circular shield at a center of the pupil, and ε is 0 when there is no shield:
$${f}_{zn} \leq \frac{1 - \sqrt{1 - {NA}^{2}} - \{ 1 - \sqrt{1 - {( NA ɛ )}^{2}} \}}{λ} .$$

17. An image estimating method configured to utilize an operating unit and image data of an object captured by an image pickup apparatus that includes an image pickup optical system, at N different positions zⱼ (1≦j≦N) that are spaced from each other at an interval Δz in an optical axis direction of the image pickup optical system, and to estimate image data at a position z (zₘᵢₙ≦z≦zₘₐₓ) in the optical axis direction, N being an integer of 2 or larger, zₘᵢₙ being a minimum value of z, and zₘₐₓ being a maximum value of z, the image estimating method comprising the steps of performing a series expansion for I(x,y,z) in a range from 1 to n₀ so as to obtain estimated image data wherein a coefficient of the series expansion is determined by a discrete cosine transform of I(x,y,zⱼ), where I(x,y,z) is a brightness distribution representative of the image data at the position z by a three-dimensional function that contains the optical axis direction and two directions orthogonal to the optical axis, I(x,y,zⱼ) is a brightness distribution representative of N pieces of image data of the object, f_{zn} is a discrete spatial frequency in the optical axis direction and expressed as f_{zn}=n/(zₘₐₓ−zₘᵢₙ+Δz) n is an integer that satisfies 0≦n<N−1, NA is a numerical aperture of the image pickup optical system on an object side, λ is a wavelength of light from the object, n₀ is a maximum of n that satisfies the following expression, a radius of a circular shield is ε times as large as a radius of a pupil of the image pickup optical system when there is the circular shield at a center of the pupil, and ε is 0 when there is no shield:
$${f}_{zn} \leq \frac{1 - \sqrt{1 - {NA}^{2}} - \{ 1 - \sqrt{1 - {( NA ɛ )}^{2}} \}}{λ} .$$

18. (canceled)

19. A non-transitory recording medium which stores a program configured to enable a computer to execute an image estimating method comprising steps of:
an image converting step of performing a frequency conversion for N pieces of image data in the optical axis direction, and of calculating N pieces of converted image data; and
a coupling step of multiplying the N pieces of converted image data by a complex number determined for the N pieces of converted image data based upon zₘᵢₙ, zₘₐₓ, z and Δz and of summing up multiplied results.

20. An image estimating apparatus configured to execute an image estimating method comprising steps of:
an image converting step of performing a frequency conversion for N pieces of image data in the optical axis direction, and of calculating N pieces of converted image data; and
a coupling step of multiplying the N pieces of converted image data by a complex number determined for the N pieces of converted image data based upon zₘᵢₙ, zₘₐₓ, z and Δz, and of summing up multiplied results.

21. A network device comprising:
a designating unit configured to designate a position at which an image estimating apparatus estimates image data of an object; and
a communicating unit configured to transmit information of the position to the image estimating apparatus, and to receive information of the image data at the position from the image estimating apparatus,
wherein the network device is connected to the image estimating apparatus, and the image estimating apparatus is configured to execute an image estimating method comprising steps of:
an image converting step of performing a frequency conversion for N pieces of image data in the optical axis direction, and of calculating N pieces of converted image data; and
a coupling step of multiplying the N pieces of converted image data by a complex number determined for the N pieces of converted image data based upon zₘᵢₙ, zₘₐₓ, z and Δz, and of summing up multiplied results.

22. A network device according to claim 21, further comprising a display unit configured to display an image at the position based upon information of I(x,y,z) received via the communication unit, where I(x,y,z) is a brightness distribution representative of the image data at the position by a three-dimensional function.

23. A method of obtaining image data of an object estimated by an image estimating apparatus, the method comprising the steps of:
displaying a position of at least one piece image data in an optical axis direction among previously estimated image data by the image estimating apparatus and N pieces of image data of an object; and
designating a position of the image data of the object in the optical axis direction at which the image estimating apparatus estimates,
wherein the image estimating apparatus is configured to execute steps of:
an image converting step of performing a frequency conversion for N pieces of image data in the optical axis direction, and of calculating N pieces of converted image data; and
a coupling step of multiplying the N pieces of converted image data by a complex number determined for the N pieces of converted image data based upon zₘᵢₙ, zₘₐₓ, z and Δz, and of summing up multiplied results.

24. The method according to claim 23, wherein the method of obtaining image data of an object estimated by the image estimating apparatus is executed by a network device connected to the image estimating apparatus.
